(19) United States
(12) Patent Application Publication
(10) Pub. No.: US 2005/0169310 A1
(43) Pub. Date: Aug. 4, 2005

(54) System and method for managing data transmissions over multiple types of transport systems

(76) Inventors: Rob Knapp, Denver, CO (US); Christopher Sundberg, Berthoud, CO (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/768,604

(22) Filed: Jan. 30, 2004

(51) Int. Cl. H04J 3/16; G06F 15/16; H04J 3/22

(52) U.S. Cl. 370/470; 709/236

(57) ABSTRACT

A system and method for transmitting a message over multiple communication networks is disclosed. In one exemplary embodiment, the present invention receives data to be transmitted to a receiver system; encrypts and compresses the data per business ruless, identifies the communication systems available to transmit the received data; determines the frame size that can be used on all of the business rule subset of identified communication systems; and passes frames of the received data to the identified communication systems, the passed frames being sized according to the determined frame size.

### COPYRIGHT

A portion of the disclosure of this patent document contains material that is subject to copyright protection. The copyright owner has no objection to the facsimile reproduction by anyone of the patent disclosure as it appears in the Patent and Trademark Office patent files or records, but otherwise reserves all copyright rights whatsoever.

### FIELD OF THE INVENTION

The present invention relates to communications management. In particular, but not by way of limitation, the present invention relates to systems and methods for managing communications over different types of communication systems.

### BACKGROUND OF THE INVENTION

Several types of wireless communication systems exist, and each has its own strengths and weakness. For example, satellite communication has an extremely broad coverage area, but it is expensive to use and transfers data slowly. WiFi, on the other hand, is relatively fast and cheap, but it has a small coverage area. Product designers, aware of each system's strengths and weaknesses, tailor their products to capitalize on a communication system's strengths. A common design choice is to select a single communication system for a particular product. A cell phone, for example, can be designed to use just CDMA.

Product designers, however, have been searching for a way to simultaneously capitalize on the strengths of multiple communication systems in a single product device. A PDA-cell phone combination, for example, could use Bluetooth to download contact information to a home computer and CDMA for phone calls. These types of devices, however, require that certain applications use only certain communication systems. A PDA-cell phone, for example, uses Bluetooth for downloading PDA data and CDMA for phone calls. Accordingly, a system is needed in which applications can dynamically select or be assigned to different communication systems. Additionally, a system is needed to manage which communication systems are used by which application and/or user.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for transmitting a message over multiple communication networks. In one exemplary embodiment, the present invention receives data to be transmitted to a receiver system; identifies the communication systems available to transmit the received data; determines the frame size that can be used on all of the identified communication systems; and passes frames of the received data to the identified communication systems, the passed frames being sized according to the determined frame size.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is an example of the architecture of the present invention;

FIG. 2 is a block diagram of the mobile system shown in FIG. 1;

FIG. 3 is a block diagram of the communication manager shown in FIG. 1; and

FIG. 4 is a block diagram of the backend system shown in FIG. 1.

### DETAILED DESCRIPTION

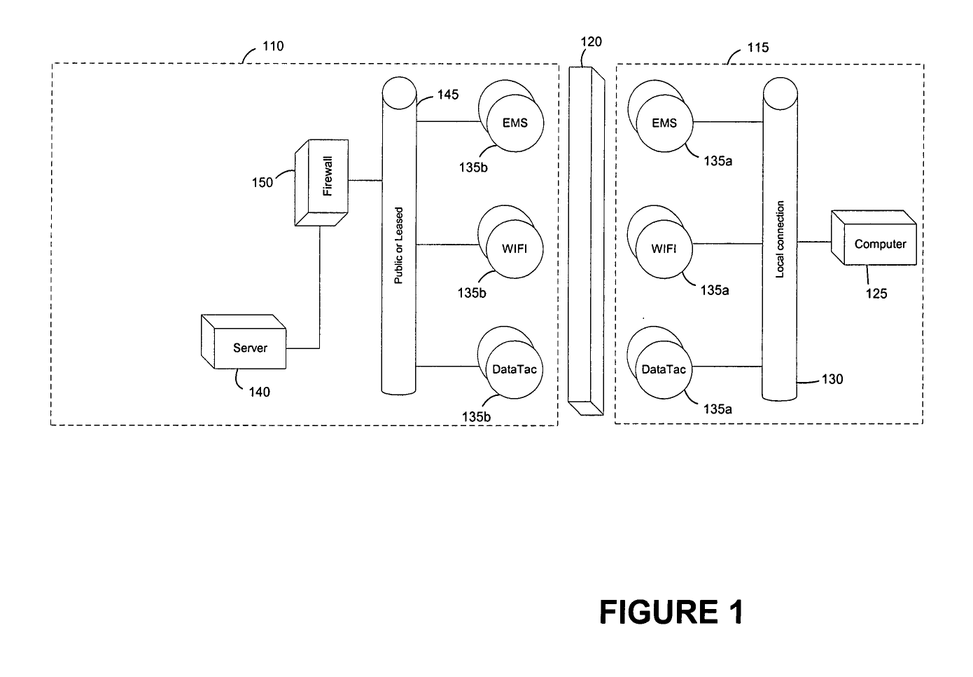

Referring now to the drawings, where like or similar elements are designated with identical reference numerals throughout the several views and referring in particular to FIG. 1, it illustrates one example of the architecture of the present invention. This embodiment includes a backend system 110 coupled to a mobile system 115 through various communication networks 120. Although not illustrated, several mobile systems can be connected to the backend system through those communication networks 120. Typical backend systems 110 include fleet management systems, emergency management systems, and asset management systems. Typical mobile systems 115 are associated with delivery vehicles, delivery personnel, emergency vehicles, emergency personnel, and remotely-located assets.

The mobile system 115 of this embodiment includes a computer system 125 such as a laptop, handheld computer, personal digital assistant, monitoring system, or any other mobile or remotely-located computer device. This computer system 125 is connected through a local connection 130 to different types of transceivers 135a, which can be incorporated into the same chip. Typical transceivers 135 operate according to the following protocols: Bluetooth, 802.11x (WiFi), GPRS (GSM), wired Ethernet, M/A-Com, CDPD, DataTac LMR, GEO Satellite Communications, EMS, and CDMA. As new transport protocols are developed, additional transceivers can be added. In other embodiments of the present invention, multiple transceivers can be replaced with a single transceiver that can be configured to operate according to any of the available transport protocols, including a Software Defined Radio.

The computer system 125 can be configured to communicate with the backend system 110 over any, some, or all of the transceivers 135. Typically, an application (not shown) in the computer system 125 that is sending data to the backend system 110 is unaware of which transceiver 135a is being used. However, status information such as each communication system's queues or send/receive status can be passed to the application. Similarly, applications (not shown) at the backend system 110 are generally unaware of which transceiver is being used, but can optionally be aware of transport status.

The backend system 110 also includes various types of transceivers 135b for communicating with the mobile system 115. These backend transceivers 135b generally are the same type of transceivers used by the mobile system 115. The transceivers 135b can be replaced with a wired gateway supplied by a transport provider in some embodiments.

In some instances, the backend system 110 may have communication capabilities beyond those of the mobile system 115. This arrangement allows legacy mobile systems to be integrated alongside new mobile systems that use the latest communication technologies.

The backend transceivers 135b are connected with an application server 140 designed to process the communications between the backend system 110 and the mobile system 115. These servers 140 are generally unaware of the particular communication system used for a communication. Often, those transceivers 135b (or gateway) are separated from the server 140 by a local network 145 and a firewall 150.

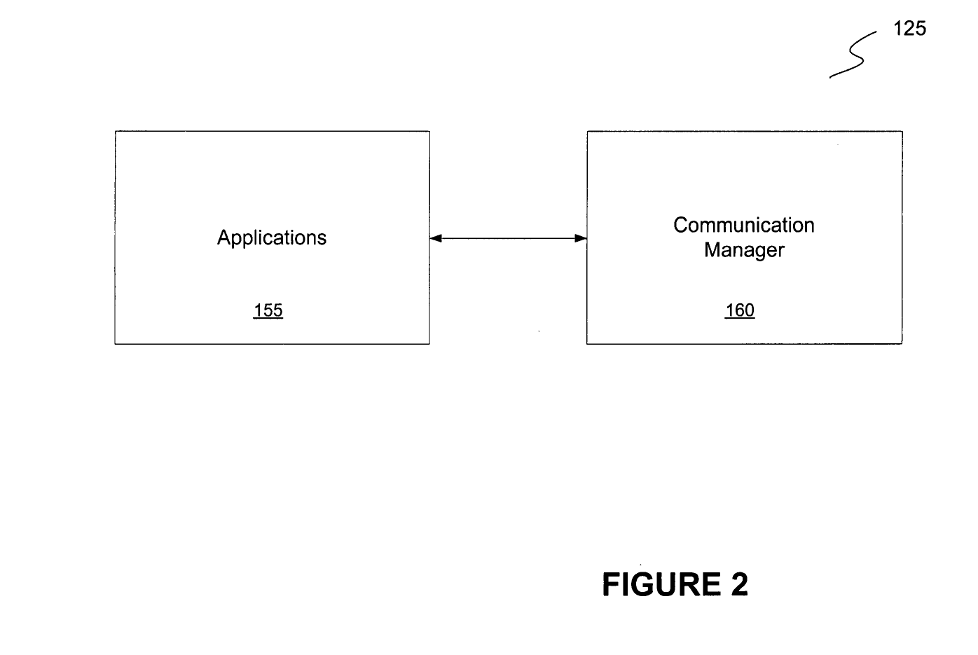

Referring now to FIG. 2, it illustrates a block diagram of the computer system 125 (shown originally in FIG. 1). This embodiment of the computer system 125 is divided into the applications 155 and the communication manager 160. The applications 155 are responsible for processing data received from the backend system 110 and for generating data to send to the backend system 110. Typical applications include delivery management and emergency management applications.

When any of the applications 155 need to send data to the backend system 110, this data is provided to the communication manager 160 using, for example, IP protocols. The communication manager 160 prepares the data to be transmitted over the communication systems 120. The applications 155 are generally unaware of which communication system 120 the communication manager 160 uses, but may optionally obtain status information. And in certain embodiments, the applications 155 believe that they are communicating directly with the backend system 110.

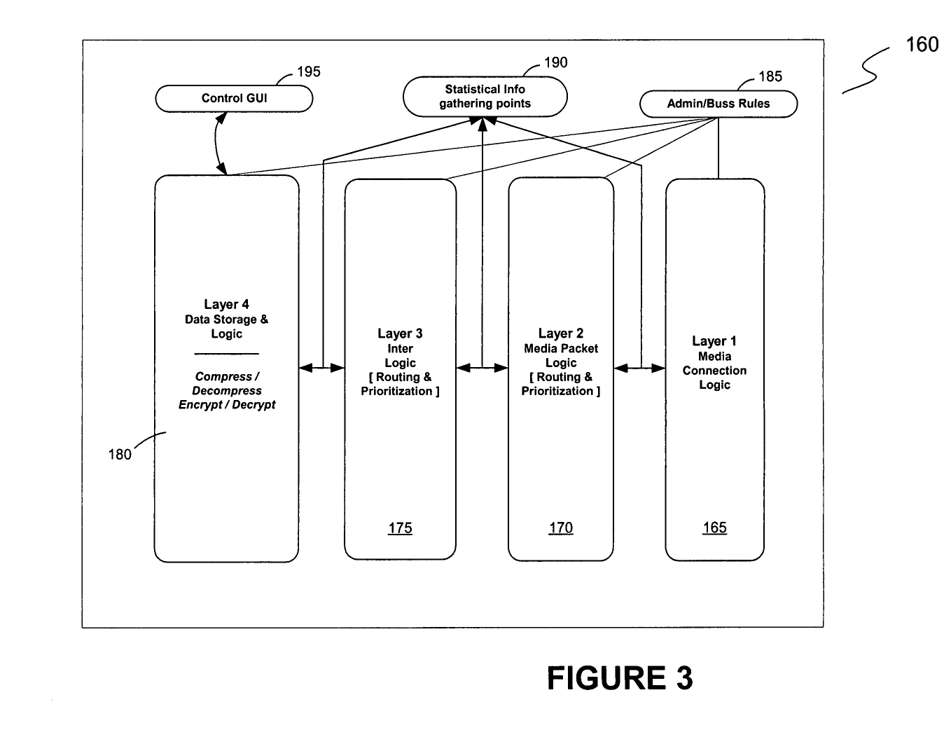

This embodiment of the communication manager 160, which is illustrated in FIG. 3, is arranged in four layers. The first layer 165 acts as the communications interface. It provides the transport connection logic; opens connections to the proper transport device (e.g., modem, NIC, Satellite transceiver); manages the transceivers; sends blocks of data received from the second layer; receives data from the transceivers; and obtains status information from the communications device. The first layer 165 can be configured to include a plurality of plug-ins for communicating with particular types of transceivers or gateways. As new communication systems are developed, new plug-ins can be added without modifying any of the applications.

The second layer 170 of the communication manager 160 provides the transport packet logic. This layer sizes messages and packets for sending to the first layer 165. The second layer 170 also reassembles messages and packets received from the first layer 165. These reassembled messages and packets are then passed to the third layer 175. The second layer 170 also contains the assured delivery logic where packets are acknowledged (successfully delivered) or non-acknowledged (to be retried). The second layer 170 and the first layer 165 generally exist for each connection between the mobile system 115 and the backend system 110.

The third layer 175 of the communication manager 160 provides security negotiations and routing between the first layer 165 interfaces. For example, this layer 175 performs the required security negotiations before data can be passed to the fourth layer 180. Additionally, the third layer 175 determines how a message or packet should be routed. For example, the third layer 175 can determine over which communication system a message should be transmitted. Generally, it makes these routing determinations based on business rules 185. These rules and security procedures are described in more detail below.

The fourth layer 180 of the communications server 160 manages actions on the data within the packets, e.g., compression/decompression and encryption/decryption of messages or packets. The fourth layer 180 can utilize any variety of encryption and compression techniques as defined by a business rule. For example, certain embodiments can use RSA's Bsafe cipher suite, Rijndael, Twofish, and/or RSA public-key encryption.

In certain embodiments, statistics about the layers activities can be collected by component 190. Similarly, the activities of the layers can be controlled through GUI 195.

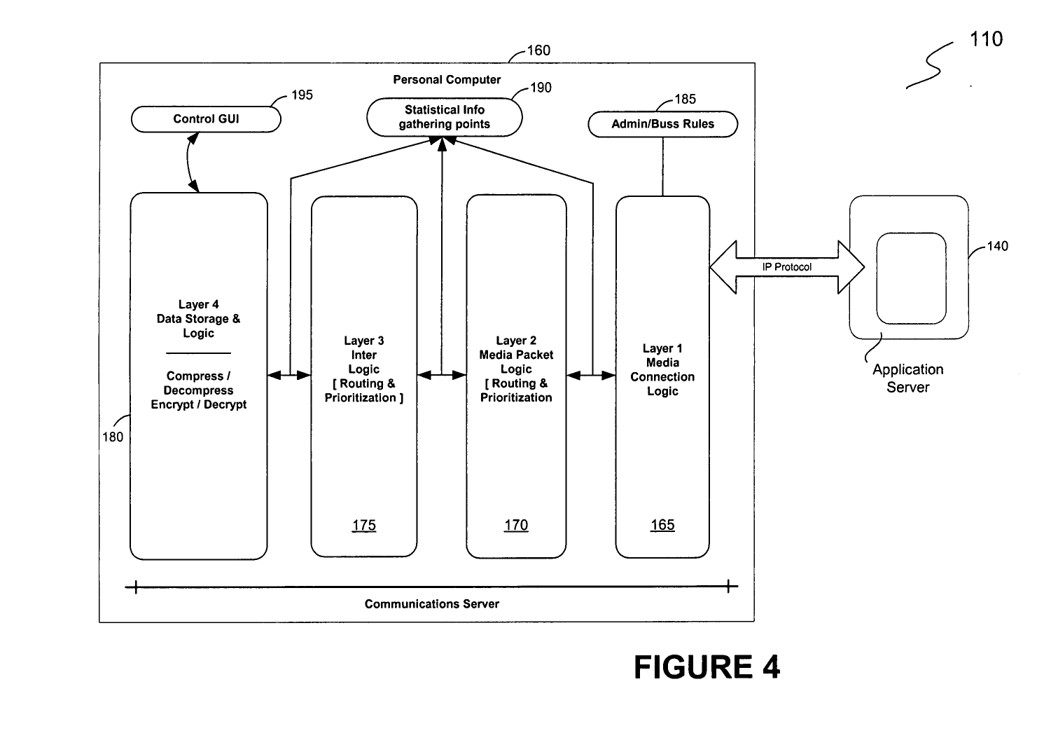

Referring now to FIG. 4, it illustrates aspects of the backend system 110 in more detail. The backend system 110 includes communication manager 160 similar to that contained in the mobile system 115. The backend system 110 or application server 140 speaks to the communication manager 160 as if it were speaking to the client directly. It is generally unaware of the complexities of compression, encryption, routing, transport control or the formatting of packets for the connected transports.

Embodiments of the present invention can be configured to provide several advantages including roaming between communications technologies, priority processing, security, bandwidth aggregation, broadcast management, and configurable business rules. Each of these advantages are described below.

Roaming Between Transport Technologies

As previously described, different embodiments of the present invention can transmit data over different communication systems or different combinations of communication systems. And by embedding these different communication technologies into the same device, embodiments of the present invention enable users to take advantage of the strengths and availability of each individual communication system. For example, the mobile system and the backend system can be set up to communicate according to the fastest available communication system. When the two systems are a few hundred yards apart, for example, the fastest available system is likely WiFi. When the two systems are separated by twenty miles, however, WiFi is no longer an option, and the fastest available system could be CDMA. In other instances the mobile system and the base system could be configured to communicate over the most cost-effective communication system or to store data until a cost-effective communication system becomes available.

The rules that govern which communication systems are used for which applications and messages are often referred to as a type of “business rule.” Business rules are discussed in greater detail below.

Nested Roaming

In one embodiment of the present invention, the mobile system can act as a Bluetooth and/or WiFi hub, thereby allowing other nearby devices to communicate with the mobile system and the backend system. For example, a delivery vehicle could be configured to act as a WiFi hub. When the delivery person enters data on a handheld computer, that data could be transmitted back to the delivery vehicle and, if appropriate, relayed to the backend system, independent of the transport available to the vehicle. Another possible application could be for emergency personnel. They could use personal radio devices to transmit data back to their vehicle, thereby extending their effective communications range. Depending upon the priority of the data, the mobile system at the emergency vehicle could relay the data to the backend system over one, some, or all of the available transports.

Priority Data Handling

One embodiment of the present invention allows data (including messages, packets and frame) to be assigned a priority. Depending upon the assigned priority, the data can be handled differently by the mobile system, the backend system, or both. For example, the mobile system could move high priority data to the front of the transmission queue for a particular communication system. Alternatively, high priority data could be moved to the front of every queue for every available communication system or moved to the front of the queue for the least congested communication system. Another example is a low priority message is currently in progress and is preempted while a high priority message is sent, then the lower priority message is resumed.

In yet other embodiments, high priority data could bypass certain layers in the communication manager. For example, an emergency call about an officer being shot does not necessarily need to be encrypted. Accordingly, the message can bypass layer four of the communication manager and be broadcast over one, some, or all of the available communication systems. Similarly, a message from the backend system to assist an officer can likely bypass the encryption or compression layer of the backend system's communication manager.

The rules governing priority can be contained in a set of business rules or in separate priority rules. Priority can be assigned to a message, packet or frame in a number of ways. Priority, for example, can be assigned based on a user, a user group, an application, the mobile system location, a message type, etc. For example, an application on the mobile system that checks vehicle records may be assigned a low priority on a particular transmission system. Similarly, most messages from parking enforcement officers may also be assigned a low priority. But particular types of messages, even from low-priority groups or users, may be assigned high priorities. A typical example of a high priority message from any user would be an emergency call for help.

Once a priority has been assigned to a message, the communication manager can handle it in various ways. For example, the communication manager could perform a lookup on queued messages and determine where in the queue the new message should be placed. Factors such as other messages' time in queue could also be considered when determining where to place the new message. Oldest messages of the highest priority in the queue are transmitted first in this embodiment.

In another embodiment, new messages are placed in the queue in the order that they were received. The process that identifies which message to transmit sorts the queue by priority and time in queue and sends the oldest message of the highest priority. In some embodiments, a message may be bumped to a higher priority if it has been in the queue for a certain length of time.

Bandwidth Aggregation

In some embodiments of the present invention, the communication manager can divide a message into frames and pass those frames over multiple communication systems. That is, the communication manager can pass different pieces of a message over different communication systems. To the user of the communication system, this appears to increase the throughput of the system; this is done by summing the bandwidths of each connected transport. Business rules establish whether or not this bandwidth aggregation is used and, if it is used, which communication systems are involved.

Assuming that bandwidth aggregation is invoked for a particular message, the message is broken into frames of a size less than or equal to the smallest payload size of the available communication systems. The communication manager then passes frames to the various communication systems as they can digest them. Thus, the communication manager can pass data to different communication systems at different rates. As the receiver receives the frames, they are reassembled into complete packets or messages.

Broadcast Management

Often the same message is sent to a number of users. And in these cases, a breakpoint exists where it is more efficient to broadcast the message to all users and filter the message at receipt so that it is only displayed to the intended subgroup. Embodiments of the present invention account for this breakpoint and manage when messages are broadcast. These embodiments also enable filtering by the receiver.

One embodiment of the present invention determines this breakpoint by the following calculation:

Ms=Message Size

Ur=Number of Users receiving the message

Ut=Number of Users on the system

Tr=Predicted explicit delivery Latency to Users. Units are User/Seconds.

Tb=Predicted Latency for broadcast. Units are User/Seconds.

Tn=Predicted blocking time for broadcast receivers who are not recipients.

Pn=Number of Packets that Ms is broken into.

Tc=Number of Concurrent Transmissions that can occur.

$$Where Tr = \frac{[ ( Pn \times Avg . Pkt Time ) + 1 ACK Time ] \times Ur}{Tc}$$

And Tb=(Pn×Avg. Pkt Broadcast Time)+(1 ACK Time×Ur)

If (Tr>(Tb+Tn))
Broadcast the message

Else
Explicitly send the message to each user.

Configurable Business Rules

Some embodiments of the present invention allow users to establish business rules for managing data transmissions. Some of the business rules already discussed include message priority and transport system selection. Other business rules can be designed to help limit loads on older hardware, seek out available transport systems, enable/disable encryption, enable/disable compression, etc.

Some embodiments of the invention allow administrators to configure the communication system to throttle bandwidth on older or more expensive transports. By way of example, business rules may be used to set encryption levels for different applications, over different transports for different users. Another example is the differing requirements of a Juvenile offenders office (JOO) versus a police officer or fireman. The JOO might possess older computers and a dialup modem; compression and encryption would be set via business rules to minimize load on the older PC and maximize usability. The policy officer's system is configured to apply strong encryption and compression to increase speed and security. While the fireman's system is configured in yet another fashion as seen fit by the administrator to best utilize existing assets while enabling communications between all users of the communication system.

Security

Embodiments of the present invention enhance security by authentication of the client device(s), the user, and the application. This multi-factor authentication allows the backend system and the mobile system to know in advance which users are expected on which devices, or which devices to allow, thereby prevents stolen hardware or mis-provisioned hardware from being able to “probe” the communication system for information.

Furthermore, in addition to these authentication transactions being encrypted, the vital user and device identifiers are hashed. Temporal encryption further increases security by changing keys at specified intervals, down to individual packets. The ability to encrypt every data packet with a different key makes attempts to hack into the network by deciphering the key for an intercepted packet or transaction exceptionally difficult.

Some embodiments of the present invention are constructed such that all data flow in the public domain is encrypted and without a proper security negotiation, it is impossible to “probe” for naming conventions or password solutions. Without the correct credentials, no data whatsoever is returned. Security is built with end-to-end encryption of data packets, hashing of UserNames, Passwords and DeviceIds.

Some embodiments use RSA's Bsafe cipher suite. Built-in at the C++ API level, Bsafe provides strong encryption and security. For strong encryption, some embodiments can support the AES (US Advanced Encryption Standard) secret-key encryption algorithm known as Rijndael, which uses 128, 192 or 256-bit keys. Embodiments can also support the Twofish encryption algorithm, a runner-up candidate for AES. For public-key encryption, certain embodiments offer the well-known RSA algorithm unlimited key bit-sizes.

All embodiments offer some cipher suite or mechanism for encrypting data. These are considered “plug-ins” and may be configured or changed easily as required.

In conclusion, the present invention provides, among other things, a system and method for managing communications over multiple types of communication systems. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

1. A method for transmitting a message over communication systems, the method comprising:
receiving data to be transmitted;
identifying which of the communication systems are available to transmit the received data;
determining the frame size that can be used on all of the identified communication systems; and
passing frames of the received data to the identified communication systems, the passed frames being sized according to the determined frame size;
whereby different frames of the received data can be transmitted over different ones of the identified communication systems.

2. The method of claim 1, wherein determining the frame size that can be used on all of the identified communication systems comprises:
determining the largest frame size that each of the identified communication systems is configured to process.

3. The method of claim 1, further comprising:
determining over which subset of the identified communication systems the received data should be transmitted.

4. The method of claim 1, further comprising:
evaluating a message type associated with the received data using a business rule; and
determining over which communication systems the received data should be transmitted based on the evaluation of the message type.

5. The method of claim 1, further comprising:
identifying an application that originated the received data; and
determining over which communication systems the received data should be transmitted based on the determined application.

6. The method of claim 1, further comprising:
identifying a user that originated the received data; and
determining over which communication systems the received data should be transmitted based on the determined user.

7. The method of claim 1, further comprising:
generating the received data at an application program.

8. The method of claim 1, further comprising:
transmitting the frames to a backend system.

9. The method of claim 8, further comprising:
receiving the frames after they are transmitted; and
reassembling the frames.

10. A system for transmitting data over multiple communication devices, the system comprising:
a plurality of transceivers, each transceiver being configured to operate according to a different communication protocol; and
a communication manager connected to the plurality of transceivers, the communication manager configured to:
identify which of the plurality of transceivers is available to transmit a data item to a remotely-located device;
determine the frame size that can be used by the identified plurality of transceivers; and
pass frames of the received data to the identified plurality of transceivers, the passed frames being sized according to the determined frame size;
whereby different frames of the received data can be transmitted by different ones of the plurality of transceivers.

11. The system of claim 10, further comprising:
a second communication manager configured to reassemble frames transmitted by the plurality of transceivers.

12. The system of claim 11, further comprising:
an application program configured to process the data item after it is reassembled by the second communication manager.

13. The system of claim 10, further comprising:
an application program configured to generate the data item.

14. The system of claim 13, wherein the data item comprises a message or a packet.

15. A method for transmitting a message over multiple communication networks, the method comprising:
receiving a message to be transmitted to a receiver system;
identifying the communication systems available to transmit the message to the receiver system; and
passing frames of the message to the identified communication systems;
whereby different frames of the message can be passed over different ones of the identified communication systems.

16. The method of claim 15, further comprising:
determining the largest frame size that each of the identified communication systems is configured to process;
wherein the passed frames are sized according to the largest frame size.

17. The method of claim 15, further comprising:
determining a frame size that a particular one of the communication systems is configured to process;
wherein the frames passed to the particular one of the communication systems are configured according to the determined frame size.

18. The method of claim 15, wherein a frame corresponds to a package of information transmitted as a single unit.

19. A communication manager for managing communications over a plurality of transceivers, the communication manager comprising:
a memory device; and
a plurality of instructions configured to:
identify which of the plurality of transceivers is available to transmit a data item to a remotely-located device;
determine the frame size that can be used by the identified plurality of transceivers; and
pass frames of the received data to the identified plurality of transceivers, the passed frames being sized according to the determined frame size;
whereby different frames of the received data can be transmitted by different ones of the plurality of transceivers.

20. A method for transmitting a packet over multiple communication networks, the method comprising:
receiving a packet to be transmitted to a receiver system;
identifying the communication systems available to transmit the packet to the receiver system; and
passing frames of the packet to the identified communication systems;
whereby different frames of the packet can be passed over different ones of the identified communication systems.

21. The method of claim 20, further comprising:
determining the largest frame size that each of the identified communication systems is configured to process;
wherein the passed frames are sized according to the largest frame size.

22. The method of claim 20, further comprising:
determining a frame size that a particular one of the communication systems is configured to process;
wherein the frames passed to the particular one of the communication systems are configured according to the determined frame size.
